(19) United States
(12) Patent Application Publication
(10) Pub. No.: US 2022/0185319 A1
(43) Pub. Date: Jun. 16, 2022

(54) VEHICLE

(71) Applicants: HYUNDAI MOTOR COMPANY, Seoul (KR); KIA CORPORATION, Seoul (KR); HYUNDAI AUTOEVER CORP., Seoul (KR)

(72) Inventors: Daegil Cho, Suwon-si (KR); Seung Hwan Shin, Seoul (KR)

(73) Assignees: HYUNDAI MOTOR COMPANY, Seoul (KR); KIA CORPORATION, Seoul (KR); HYUNDAI AUTOEVER CORP., Seoul (KR)

(21) Appl. No.: 17/506,441

(22) Filed: Oct. 20, 2021

(30) Foreign Application Priority Data
Dec. 10, 2020 (KR) 10-2020-0172549

(51) Int. Cl. B60W 60/00; G08G 1/01; B60W 40/06; G01S 17/931; G01S 13/931

(52) U.S. Cl. CPC B60W 60/001; G08G 1/0104; B60W 40/06; B60W 2554/404; G01S 13/931; B60W 2420/52; B60W 2420/42; G01S 17/931

(57) ABSTRACT

Provided is a vehicle capable of performing safe autonomous driving by selecting a recognition area of a sensor for performing autonomous driving and maximizing the performance of the sensor according to a situation. The vehicle for performing autonomous driving includes a communication part, a driving part configured to drive the vehicle and acquire information about an element that drives the vehicle, an information acquisition part including a camera, a radar and a LiDAR, and a control part. The control part is configured to determine road condition information of a road on which the vehicle travels based on a signal acquired from the communication part, determine travel information of the vehicle based on information acquired from the driving part, receive a recognition result of the information acquisition part, determine a required performance based on the road condition information, the vehicle travelling information, and the recognition result, and change an object recognition.

### CROSS-REFERENCE TO RELATED APPLICATION

This application is based on and claims priority under 35 U.S.C. § 119 to Korean Patent Application No. 10-2020-0172549, filed on Dec. 10, 2020 in the Korean Intellectual Property Office, the disclosure of which is incorporated herein by reference.

### BACKGROUND

### 1. Field

The present disclosure relates to a vehicle that performs autonomous driving based on signals acquired from a camera and various sensors.

### 2. Description of the Related Art

Autonomous driving technology for vehicles is a technology that enables a vehicle to automatically drive by understanding the road conditions without a driver controlling a brake, a steering wheel, an accelerator pedal, or the like.

Autonomous driving technology is a key technology for the realization of smart cars, and for autonomous vehicles, includes a highway driving support system (HAD) for automatically maintaining the distance between vehicles, a blind spot detection (BSD) system for sensing a neighboring vehicle during backward driving and producing an alert, an automatic emergency braking (AEB) system for operating a braking apparatus in case of a failure to recognize a preceding vehicle, a lane departure warning system (LDWS), a lane keeping assist system (LKAS) for preventing a drift out of a lane without a turn signal, an advanced smart cruise control (ASCC) system for performing auto cruise at a designated speed while maintaining a distance between vehicles, a traffic jam assistant (TJA) system, a parking collision-avoidance assist (PCA) system, and the like.

In particular, for the PCA system, research on sensors used for lateral collision avoidance assist and a control logic thereof is being actively conducted.

In performing the above-described autonomous driving, the vehicle may use signals acquired by various sensors provided in the vehicle.

According to an embodiment, the vehicle may perform the above-described autonomous driving using sensors, such as a radar and a LiDAR, and a camera.

On the other hand, sensors used for autonomous driving perform recognition, determination, and control to achieve maximum performance based on a fixed recognition range.

In the conventional technology, there is a limitation in that only a fixed recognition performance is acquired with a fixed recognition range and a fixed hardware performance of a sensor. Therefore, studies to solve such limitations are being actively conducted.

### SUMMARY

Therefore, it is an object of the present disclosure to provide a vehicle capable of performing safe autonomous driving by selecting a recognition area of a sensor for performing autonomous driving and maximizing the performance of the sensor according to a situation.

Additional aspects of the present disclosure are set forth in part in the description which follows and, in part, should be understood from the description, or may be learned by practice of the present disclosure.

According to an aspect of the present disclosure, there is provided a vehicle performing autonomous driving, the vehicle including: a communication part; a driving part configured to drive the vehicle and acquire information about an element that drives the vehicle; an information acquisition part including a camera, a radar and a LiDAR; and a control part. In one embodiment, the control part is configured to: determine road condition information of a road on which the vehicle travels based on a signal acquired from the communication part; determine travel information of the vehicle based on information acquired from the driving part; receive a recognition result of the information acquisition part; determine a required performance based on the road condition information, the vehicle travelling information, and the recognition result; and change an object recognition performance of the information acquisition part based on the required performance.

The control part, when the required performance is related to improving a recognition accuracy of one area of a surrounding area of the vehicle, may change a recognition area of the radar to a vicinity of the one area.

The control part, when the required performance is related to acquiring information about a moving object around the vehicle, may change a recognition area of the radar to a vicinity of the moving object.

The control part, when the required performance is related to improving a resolution to acquire information about one area of a surrounding area of the vehicle, may change a recognition area of the LiDAR to a center of the one area.

The control part, when the required performance is related to improving a classification characteristic of an object corresponding to one area around the vehicle, may improve a classification characteristic of a part corresponding to the one area in an image acquired by the camera to a predetermined range.

The control part may be configured to, among pieces of surrounding information about a specific area acquired by a plurality of modules forming the information acquisition part, in response to an existence of at least one module having acquired different surrounding information about the specific area, perform control to cause the information acquisition part to acquire the surrounding information by assigning a high weight to the at least one module that has acquired the different surrounding information.

The control part may be configured to, based on a performance of at least one module that forms the information acquisition part, determine the required performance for changing a recognition weight of the at least one module. The control part may also be configured to change the object recognition performance of the information acquisition part based on the required performance.

The control part may be configured to, based on a type of an object included in a surrounding image of the vehicle acquired by the information acquisition part, determine the required performance for changing a weight of the surrounding image of the vehicle corresponding to the object.

### BRIEF DESCRIPTION OF THE DRAWINGS

These and/or other aspects of the present disclosure should become apparent and more readily appreciated from the following description of the embodiments, taken in conjunction with the accompanying drawings of which:

FIG. 1 is a control block diagram illustrating a vehicle according to an embodiment;

FIG. 2 is a diagram illustrating recognition ranges of sensors provided in a vehicle according to an embodiment;

FIG. 3 is a diagram for describing areas recognized by a camera according to an embodiment;

FIG. 4 is a diagram for describing areas recognized by a radar according to an embodiment;

FIGS. 5A and 5B are diagrams for describing areas recognized by a LiDAR according to an embodiment;

FIGS. 6A and 6B are diagrams for describing a recognition area of a sensor and a recognition area of a camera when a brake pedal is operated according to an embodiment;

FIGS. 7A and 7B are diagrams for describing a recognition area of a sensor and a recognition area of a camera when an accelerator pedal is operated according to an embodiment;

FIGS. 8A and 8B are diagrams for describing a recognition area of a sensor and a recognition area of a camera when a steering wheel or steering wheel pedal is operated according to an embodiment;

FIG. 9 is a diagram for describing an operation of changing a weight of an image based on a type of an object included in an image of a surrounding of a vehicle according to an embodiment;

FIG. 10 is a diagram for describing an operation of changing a recognition weight of a module based on the performance of the module according to an embodiment; and

FIG. 11 is a flowchart according to an embodiment.

### DETAILED DESCRIPTION

Like numerals refer to like elements throughout the specification. Not all elements of embodiments of the present disclosure will be described, and descriptions of what are commonly known in the art or what overlap each other in the embodiments are omitted. The terms as used throughout the specification, such as “˜ part”, “˜ module”, “˜ member”, “˜ block”, and the like, may be implemented in software and/or hardware, and a plurality of “˜ parts”, “˜ modules”, “˜ members”, or “˜ blocks” may be implemented in a single element, or a single “˜ part”, “˜ module”, “˜ member”, or “˜ block” may include a plurality of elements.

It is further understood that the term “connect” or its derivatives refer both to direct and indirect connection, and the indirect connection includes a connection over a wireless communication network.

It is further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof, unless the context clearly indicates otherwise.

Although the terms “first,” “second,” “A,” “B,” and the like may be used to describe various components, the terms do not limit the corresponding components, but are used only for the purpose of distinguishing one component from another component.

As used herein, the singular forms “a,” “an” and “the” are intended to include the plural forms as well, unless the context clearly indicates otherwise.

Reference numerals used for method steps are just used for convenience of explanation, but not to limit an order of the steps. Thus, unless the context clearly dictates otherwise, the written order may be practiced otherwise.

When a component, device, element, or the like of the present disclosure is described as having a purpose or performing an operation, function, or the like, the component, device, or element should be considered herein as being “configured to” meet that purpose or to perform that operation or function.

Hereinafter, the principles and embodiments of the present disclosure are described with reference to the accompanying drawings.

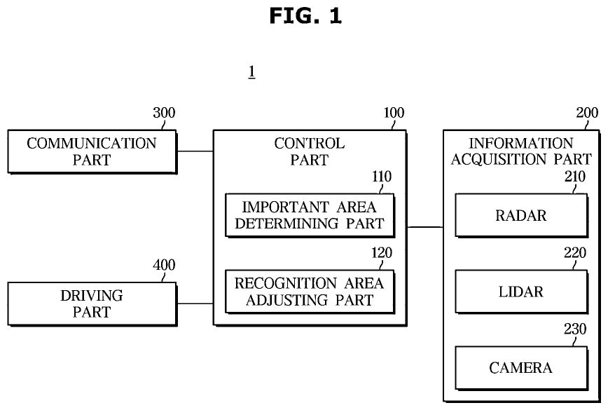

FIG. 1 is a control block diagram illustrating a vehicle according to an embodiment.

Referring to FIG. 1, a vehicle 1 may include a communication part 300, a driving part 400, a control part 100, and an information acquisition part 200.

The communication part 300 may communicate with an external server and devices.

Specifically, the communication part 300 may receive road condition information of a road on which the vehicle travels.

The road condition information may include a Global Positioning System (GPS) signal and map information transmitted from an external server.

The communication part 300 may include one or more components that enable communication with an external device, and may include, for example, at least one of a short-range communication module, a wired communication module, and a wireless communication module.

The driving part 400 may be provided as a device capable of driving a vehicle.

According to an embodiment, the driving part 400 may include an engine, and may include various components for driving the engine.

Specifically, the driving part 400 may include a brake and a steering device and may be provided without limitation as long as it can implement driving of a vehicle.

The information acquisition part 200 may include a radar 210, a LiDAR 220, and a camera 230.

The radar sensor 210 may refer to a sensor that emits an electromagnetic wave approximating microwaves (e.g., ultrahigh frequency wave, a wavelength of 10 cm to 100 cm) to an object, and receives the electromagnetic wave reflected from the object, to detect the distance, direction, altitude, and the like with the object.

The LiDAR sensor 220 may refer to a sensor that emits a laser pulse, receives the light reflected from a surrounding target object, and measures the distance to the object to thereby precisely depict a surrounding.

The camera 230 may be provided as a component to acquire a surrounding image of the vehicle 1.

According to an embodiment, a camera 230 may be provided at the front, rear, and side of the vehicle 1 to acquire an image.

The camera 230 installed in the vehicle may include a charge-coupled device (CCD) camera or a complementary metal-oxide semiconductor (CMOS) color image sensor. The CCD and the CMOS may refer to a sensor that converts light received through a lens of the camera 230 into an electric signal. In detail, the CCD camera 230 refers to an apparatus that converts an image into an electric signal using a charge-coupled device. In addition, a CMOS image sensor (CIS) refers to a low-consumption and low-power type image pickup device having a CMOS structure, and serves as an electronic film of a digital device. In general, the CCD has a sensitivity superior than that of the CIS and thus is widely used in the vehicle 1, but the present disclosure is not limited thereto.

The control part 100 may include an important area determining part 110 and a recognition area adjusting part 120.

The control part 100 may determine road condition information of a road on which the vehicle travels based on a signal acquired from the communication part 300.

The road condition information may refer to a concept including road information determined by precision map information, such as a road curvature, a speed limit, and/or a road width. The road condition information may also refer to concepts including road surrounding information and a degree of risk determined based on traffic information, accident information, and accident frequency/history information.

The control part 100 may determine vehicle travelling information based on information acquired from the driving part 400.

The travelling information of the vehicle 1 may refer to information including a vehicle behavior based on sensors of the vehicle 1, such as a steering angle, a brake pedal, an accelerator pedal, a turn indicator, a gear state, revolutions per minute (RPM), a braking pressure, an acceleration, and a yaw rate.

In addition, the control part 100 may receive a recognition result of the information acquisition part 200.

The recognition result may refer to a sensor performance degradation or a sensor abnormal state, such as recognition errors of sensors based on radar, camera, and LiDAR information.

The control part 100 may determine a required performance (e.g., a required operation) based on the road condition information, the vehicle travelling information, and the recognition result.

The required performance may include a recognition priority set by the vehicle 1 for each recognition area around the vehicle 1.

The control part 100 may change an object recognition performance of the information acquisition part 200 based on the required performance.

The changing of the object recognition performance may refer to an operation of changing the use priority of a radar, a LiDAR, and a camera in a specific area, or changing the weight and priority of an area acquired by each module.

The control part 100 may, when the required performance is an operation of improving a recognition accuracy of one area of a surrounding area of the vehicle 1, change a recognition area of the radar 210 to a vicinity of the one area.

In other words, when acquiring information about an object existing in a specific area, the control part 100 may more accurately acquire information about the corresponding area while less accurately acquiring information about the remaining area using the radar 210.

The controller 100 may, when the required performance is related to acquiring information about a moving object around the vehicle 1, change the recognition area of the radar 210 to a vicinity of the moving object. In other words, the control part 100 may acquire motion information of a surrounding object using the radar 210, and if there is a specific object, may improve the recognition accuracy to acquire motion information of the object in the corresponding area.

The control part 100 may, when the required performance is related to acquiring information about one area of a surrounding area of the vehicle 1 by improving the resolution, change the recognition area of the LiDAR 220 to the center of the one area.

The control part 100 may, when the required performance is related to improving a classification characteristic of an object corresponding to one area around the vehicle 1, improve a classification characteristic of a part corresponding to the one area in an image acquired by the camera 230 to a predetermined range.

As is described below, the camera 230 may acquire an image of a surrounding area of the vehicle 1 and classify an object in a specific area of each area. Accordingly, the control part 100, when there is a required performance for improving the classification characteristic of a specific area, may improve the classification characteristic of the corresponding area and reduce the classification characteristic of the other areas.

Among pieces of surrounding information of a specific area acquired by a plurality of modules constituting the information acquiring part 200, the control part 100, in response to an existence of at least one module having acquired different surrounding information of the specific area, may perform control to cause the information acquisition part 200 to assign a higher weight to the at least one module, and acquire the surrounding information.

The controller 100, based on a performance of at least one module that forms the information acquisition part 200, may determine the required performance for changing a recognition weight of the at least one module, and change the object recognition performance of the information acquisition part 200 based on the required performance.

Specifically, when a specific module among the plurality of modules has a performance different from those of other modules and thus provides information different from that acquired by the other modules, the control part 100 may change the object recognition performance of the corresponding module to acquire information about a surrounding object.

The controller 100, based on the type of an object included in a surrounding image of the vehicle 1 acquired by the information acquisition part 200, may determine the required performance for changing a weight of the surrounding image of the vehicle 1 corresponding to the object. The operation may include, when an object is included in a surrounding image of the vehicle 1, assigning a higher weight and priority to an area in which the image is located and acquiring object information. Details thereof are described below.

The control part 100 may include a memory (not shown) for storing data regarding an algorithm for controlling the operations of the components of the vehicle 1 or a program that represents the algorithm. The control part 100 may also include a processor (not shown) that performs the above described operations using the data stored in the memory. In this case, the memory and the processor may be implemented as separate chips. Alternatively, the memory and the processor may be implemented as a single chip.

At least one component may be added or omitted to correspond to the performances of the components of the vehicle shown in FIG. 1. In addition, the mutual positions of the components may be changed to correspond to the performance or structure of the system.

Some of the components shown in FIG. 1 may refer to a software component and/or a hardware component, such as a Field Programmable Gate Array (FPGA) and an Application Specific Integrated Circuit (ASIC).

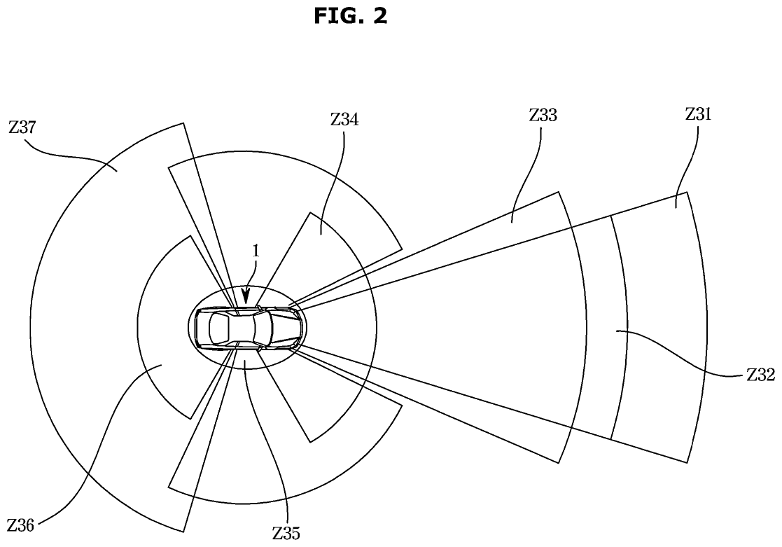

FIG. 2 is a diagram illustrating recognition ranges of sensors provided in a vehicle according to an embodiment.

Referring to FIG. 2, an area in which surrounding information of the vehicle 1 is acquired by the information acquisition part 200 with respect to the vehicle 1 is shown.

Specifically, a narrow-angle front camera Z31 among the cameras 230 of the vehicle 1 may acquire information about the vehicle 1 up to a distance of 250 m in front of the vehicle 1.

In addition, a radar sensor Z32 provided in the vehicle 1 may acquire information about the vehicle 1 up to 160 m in front of the vehicle 1.

In addition, a main front camera Z33 among the cameras 230 provided in the vehicle 1 may acquire information about the vehicle 1 up to a distance of 150 m in front of the vehicle 1. In addition, the main front camera Z33 may acquire a wider range of information compared to the narrow-angle front camera Z31.

In addition, a wide-angle front camera Z34 among the cameras 230 provided in the vehicle 1 may acquire information about the vehicle 1 up to a distance of 60 m in front of the vehicle 1. The wide-angle front camera Z34 may acquire a wider range of surrounding information of the vehicle 1 compared to the narrow-angle front camera Z31 or the main front camera Z33.

In addition, an ultrasonic sensor Z35 provided in the vehicle 1 may acquire information about a surrounding of the vehicle 1 in a range of about 8 m around the vehicle 1.

On the other hand, a side camera Z36 facing rearward among the cameras 230 provided in the vehicle 1 may acquire information about the vehicle 1 up to a distance of 100 m behind the vehicle 1. On the other hand, a rear camera Z37 facing rearward may acquire information about the vehicle 1 up to a distance of 100 m behind the vehicle 1.

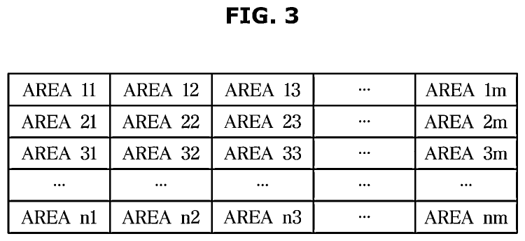

On the other hand, an area shown in FIG. 3 is only one embodiment of the present disclosure, and there is no limitation on the configuration of the information acquisition part 200 or the area in which the information obtaining part 200 acquires information about a surrounding of the vehicle 1.

FIG. 3 is a diagram for describing areas recognized by a camera according to an embodiment.

Referring to FIG. 3, an image acquired by the camera 230 provided in the vehicle 1 is illustrated.

Referring to FIG. 3, the image acquired by the camera 230 may be classified into areas from area 11 to area nm.

The camera 230 may have a superior object classification performance compared to other sensors. In addition, the camera 230 may process a recognition type for each selected recognition area.

On the other hand, the control part 100 may determine a required performance for different classification performance in the image acquired by the camera.

For example, when an object to be identified exists in areas 22, 23, 34, and 33, the control part 100 may improve the classification performances of the corresponding areas and reduce the classification performances of the remaining areas.

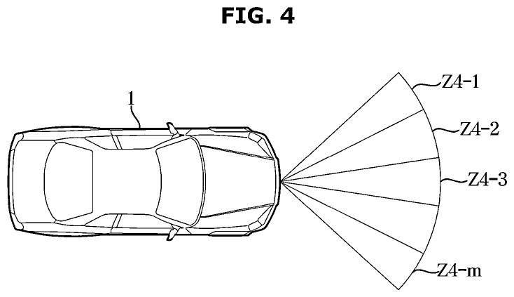

FIG. 4 is a diagram for describing areas recognized by a radar according to an embodiment.

Referring to FIG. 4, an area in which the radar 210 provided in the vehicle 1 recognizes the surroundings is illustrated. The area recognized by the radar 210 may be classified into areas from area Z4-1 to area Z4-m.

When a specific area needs to have an improved recognition accuracy, the recognition area of the radar 210 may be selectively applied to improve the recognition accuracy.

In addition, when the speed and distance accuracy need to be improved, the recognition area of the radar 210 may be selectively applied.

The area around the vehicle recognized by the radar 210 may include left and right areas in front of the vehicle 1 shown in FIG. 4.

For example, when an object is located in an area Z4-2, the control part 100 may assign the area Z4-2 with a higher weight and assign the remaining areas with lower weights to acquire a larger amount of information about the corresponding area.

In addition, according to another embodiment, when an object is located in an area Z4-1 and motion information of the object located in the corresponding area is acquired, the control part 100 may assign the area Z4-1 with a higher weight and assign the remaining areas with lower weights to acquire a larger amount of information about the corresponding area

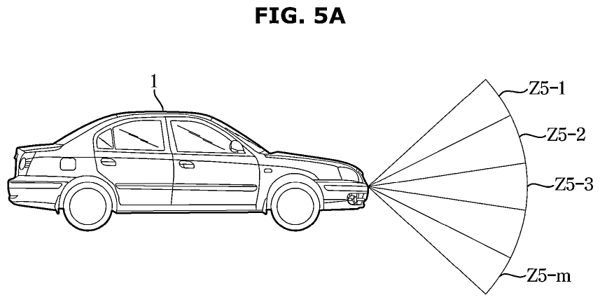

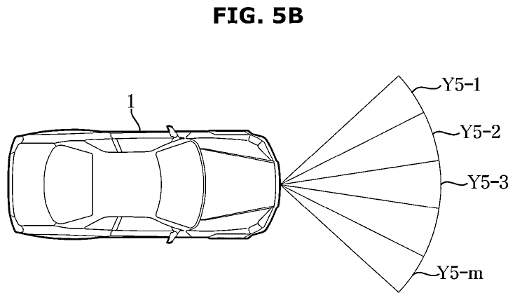

FIGS. 5A and 5B are diagrams for describing areas recognized by a LiDAR according to an embodiment.

FIG. 5A is a diagram illustrating an upper-lower recognition area of the LiDAR, and FIG. 5B is a diagram illustrating a left-right recognition area of the LiDAR.

Referring to FIG. 5A, the LiDAR 220 provided in the vehicle 1 has an upper-lower direction recognition area that is variable. Referring to FIG. 5B, the LiDAR 220 also has a left-right direction recognition area that is variable.

When the resolution of a specific area needs to be improved, the control part 100 may improve the resolution by narrowing the recognition area to the corresponding area. When the distance accuracy needs to be improved, the control part 100 selectively applies the recognition area.

For example, when an object is located in an area of Z5-2, the control part 100 may determine the area Z5-2 area to have a higher resolution and acquire a larger amount of information about the corresponding area.

In addition, according to another embodiment, when an object is located in an area Y5-2, the control part 100 may determine the area Y5-2 to have a higher resolution and acquire a larger amount of information about the area Y5-2.

The operations shown in FIGS. 3 to 5B describe the recognition areas of the camera 230, the radar 210, and the LiDAR 220 included in the information acquisition part 200 according to an embodiment of the present disclosure, and there is no limitation in the operation of changing a specific recognition area according to the required performance.

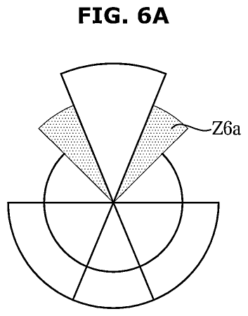

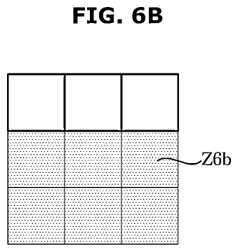

FIGS. 6A and 6B are diagrams for describing a recognition area of a sensor and a recognition area of a camera when a brake pedal is operated.

Referring to FIGS. 6A and 6B, in a situation in which the brake pedal is operated, there is a high probability that an obstacle exists on a lane. In addition, there is a high probability that an obstacle exists in a nearby lane of the vehicle 1, and there is a high probability that a nearby vehicle turns or change lanes. Therefore, the control part 100 may determine a front area of the radar 210 and the LiDAR 220 as a specific area, improve the recognition accuracy of the corresponding area, and improve the resolution (Z6a).

In addition, with regard to the recognition of the camera 230, the control part 100 may improve the classification characteristics of lower part images in a surrounding image of the vehicle 1 (Z6b).

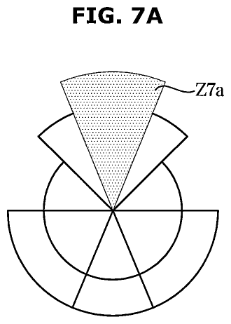

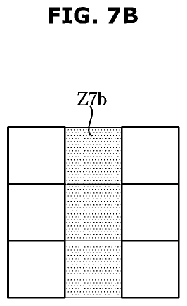

FIGS. 7A and 7B are diagrams for describing a recognition area of a sensor and a recognition area of a camera when an accelerator pedal is operated.

A situation in which the accelerator pedal of the vehicle 1 is operated may represent a situation in which the probability of driving straight in the lane is high.

Accordingly, in this case, the control part 100 may determine a distant area among front areas of the radar 210 and the LiDAR 220 as a specific area, improve the recognition accuracy of the corresponding area, and improve the resolution (Z7a).

In addition, with regard to the recognition of the camera 230, the control part 100 may improve the classification characteristics of images of central areas of upper and lower parts in the surrounding image of the vehicle 1 (Z6b).

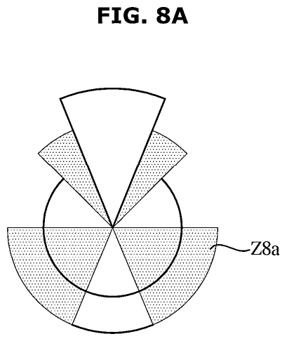

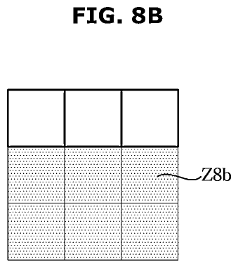

FIGS. 8A and 8B are diagrams for describing a recognition area of a sensor and a recognition area of a camera when a steering wheel or steering wheel pedal (e.g., turn signal) is operated.

A situation in which the steering wheel or steering wheel pedal of the vehicle is operated may represent a case in which there is a high probability that a lane change to the left or right and/or a left or right turn may occur.

In this case, the control part 100 may determine side areas of the radar 210 and the LiDAR 220 as a specific area, improve the recognition accuracy of the corresponding area, and improve the resolution (Z8a).

In addition, with regard to the recognition of the camera 230, the control part 100 may improve the classification characteristics of the images of lower and left/right sides of the surrounding image of the vehicle 1 (Z8b).

The operation described with reference to FIGS. 6A to 8B is an example of the operation of changing the object recognition performance by reflecting each required performance, and there is no limitation on the operation of changing the recognition performance of the radar 210, the LiDAR 220, and the camera 230.

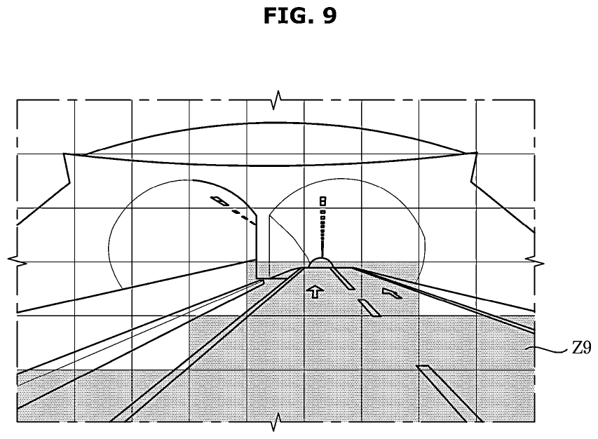

FIG. 9 is a diagram for describing an operation of changing a weight of an image based on a type of an object included in a surrounding image of a vehicle according to an embodiment.

Referring to FIG. 9, the vehicle 1 may determine information about a front object based on an image acquired by the camera 230 and data received by the communication part 300.

FIG. 9 illustrates an example of the vehicle 1 entering a tunnel.

The vehicle 1 may recognize that a tunnel exists in front of the vehicle 1 through map information received by the communication part 300, determine an entry area Z9 as an important area, and improve the classification performance of the camera 230. The improving of the classification performance may include an operation of increasing the weight of the entry area Z9 and decreasing the weight of the remaining areas.

In addition, in this case, the vehicle 1 may determine the recognition area of the radar 210 as the entry area Z9 and may increase the resolution of the LiDAR 220 to the corresponding area.

In FIG. 9, a tunnel has been described as an example, but the type of the object may be a moving object rather than a fixed object, and there is no limitation on the type of the object.

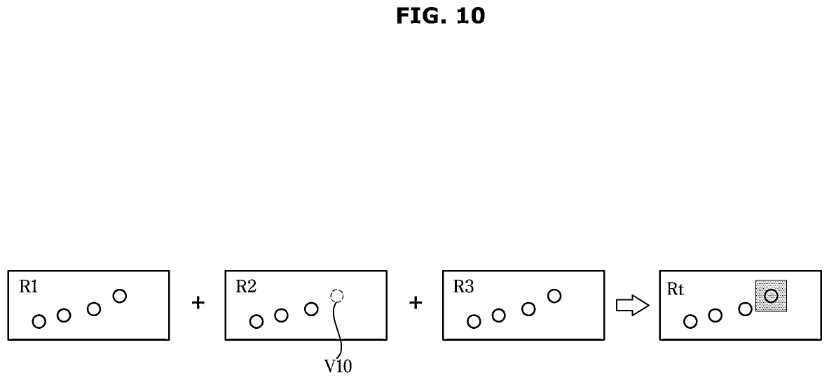

FIG. 10 is a diagram for describing an operation of changing a recognition weight of a module based on the performance of the module according to an embodiment.

Referring to FIG. 10, the control part 100, based on the performance of at least one module constituting the information acquisition part 200, may determine the required performance for changing the recognition weight of the at least one module, and change the object recognition performance of the information acquisition part 200 based on the required performance.

In FIG. 10, R1 may indicate a data result recognized by the radar 210, R2 may indicate a result recognized by the camera 230, and R3 may indicate a result recognized by the LiDAR 220.

In addition, the control part 100 may determine the final surrounding object information using R1, R2, and R3 (Rt).

In the example shown in FIG. 10, a part V10 is omitted from the surrounding object information acquired by the camera 230. Therefore, information acquired by the camera 230 is different from information acquired by each module, and thus the control part 100 determines the required performance for determining the weight of the camera 230 to be high, and based on the required performance, may recognize the part V10 in detail using the camera 230.

On the other hand, while FIG. 10 illustrates an example of when the camera 230 fails to detect a specific object, when the radar 210 and the LiDAR 220 fail to detect a specific object, information about the surrounding object may be acquired by assigning a higher weight to each of the radar 210 and the LiDAR 220. Thus, even in the case of an erroneous detection, the above operation may be performed.

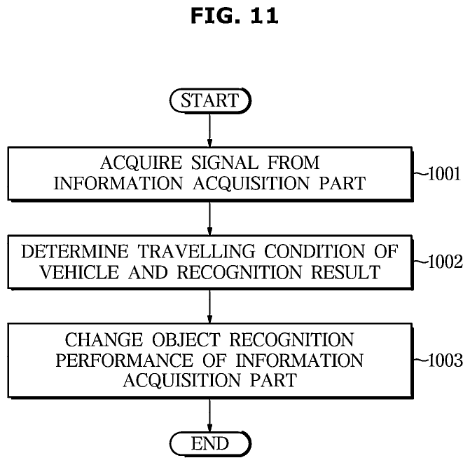

FIG. 11 is a flowchart according to an embodiment.

Referring to FIG. 11, signals may be acquired from the radar 210, the LiDAR 220, and the camera 230 provided in the vehicle 1 (1001).

The control part 100 may determine the travelling condition of the vehicle and the recognition result based on the signals (1002). As described above, the travelling situation may represent a concept including a road situation around the vehicle 1 and a travelling situation of the vehicle 1. The control part 100 may change the object recognition performance of the information acquisition part 200 based on the travelling condition of the vehicle 1 and the recognition result (1003). The changing of the object recognition performance may include changing the recognition area of the radar 210, improving the classification performance of the camera 230, and improving the resolution of the LiDAR 220.

As should be apparent from the above, the vehicle according to an embodiment of the present disclosure can perform safe autonomous driving by selecting a recognition area of a sensor for performing autonomous driving and maximizing the performance of the sensor according to a situation.

What is claimed is:

1. A vehicle performing autonomous driving, the vehicle comprising:
a communication part;
a driving part configured to drive the vehicle and acquire information about an element that drives the vehicle;
an information acquisition part including a camera, a radar and a LiDAR; and
a control part configured to:
determine road condition information of a road on which the vehicle travels based on a signal acquired from the communication part;
determine travel information of the vehicle based on information acquired from the driving part;
receive a recognition result of the information acquisition part;
determine a required performance based on the road condition information, the vehicle travelling information, and the recognition result; and
change an object recognition performance of the information acquisition part based on the required performance.

2. The vehicle of claim 1, wherein the control part, when the required performance is related to improving a recognition accuracy of one area of a surrounding area of the vehicle, changes a recognition area of the radar to a vicinity of the one area.

3. The vehicle of claim 1, wherein the control part, when the required performance is related to acquiring information about a moving object around the vehicle, changes a recognition area of the radar to a vicinity of the moving object.

4. The vehicle of claim 1, wherein the control part, when the required performance is related to improving a resolution to acquire information about one area of a surrounding area of the vehicle, changes a recognition area of the LiDAR to a center of the one area.

5. The vehicle of claim 1, wherein the control part, when the required performance is related to improving a classification characteristic of an object corresponding to one area around the vehicle, improves a classification characteristic of a part corresponding to the one area in an image acquired by the camera to a predetermined range.

6. The vehicle of claim 1, wherein the control part is configured to, among pieces of surrounding information about a specific area acquired by a plurality of modules forming the information acquisition part, in response to an existence of at least one module having acquired different surrounding information about the specific area, perform control to cause the information acquisition part to acquire the surrounding information by assigning a high weight to the at least one module that has acquired the different surrounding information.

7. The vehicle of claim 1, wherein the control part is configured to, based on a performance of at least one module that forms the information acquisition part,
determine the required performance for changing a recognition weight of the at least one module; and
change the object recognition performance of the information acquisition part based on the required performance.

8. The vehicle of claim 1, wherein the control part is configured to, based on a type of an object included in a surrounding image of the vehicle acquired by the information acquisition part, determine the required performance for changing a weight of the surrounding image of the vehicle corresponding to the object.
